(19) United States
(12) Patent Application Publication
(10) Pub. No.: US 2012/0141176 A1
(43) Pub. Date: Jun. 7, 2012

(54) METHOD FOR FORMING HIGH GLOSSY PRINTED MATTER

(75) Inventors: Asao Matsushima, Tokyo (JP); Tatsuya Nagase, Tokyo (JP); Yasuko Uchino, Tokyo (JP); Aya Shirai, Tokyo (JP); Ryuichi Hiramoto, Tokyo (JP); Michiyo Fujita, Tokyo (JP)

(73) Assignee: KONICA MINOLTA BUSINESS TECHNOLOGIES, INC., Tokyo (JP)

(21) Appl. No.: 13/303,836

(22) Filed: Nov. 23, 2011

(30) Foreign Application Priority Data
Dec. 6, 2010 (JP) 2010-271232

(51) Int. Cl. G03G 15/20

(52) U.S. Cl. 399/341

(57) ABSTRACT

Provided is a method for forming a printed mater having high glossiness (for example, glossiness 80 or more by measuring angle of 20°) via high glossiness providing apparatus. A method for forming a high glossy printed matter comprising at least steps of (a) heating and melting a clear toner supplied on an image support material, (b) bringing the image support material at a side in which the a clear toner is supplied into contact with a belt, and cooling the transparent toner while contacting with the belt, and (c) releasing the image support material from the belt, wherein the clear toner comprises at least a resin and a wax, a glass transition point (Tg) of the resin is not less than 30° C. and not more than 70° C., and a crystallization temperature (Tc) of the wax is not less than 60° C. and not more than 99° C.

This application is based on Japanese Patent Application No. 2010-271232 filed on Dec. 6, 2010, in Japanese Patent Office, the entire content of which is hereby incorporated by reference.

### TECHNICAL FIELD

The present invention relates to a method for forming a high glossy printed matter.

### BACKGROUND OF THE INVENTION

Recently, the printed image typified by photographic image and poster is formed by an ink-jet apparatus or an electrophotographic image forming apparatus additionally to usual silver halide photographic system and gravure printing method.

For instance, formation of an fine dot image on a level of 1,200 dpi (dpi: dot number per inch (2.54 cm)) is made possible in the field of the image forming technology of electrophotography such as copying machine or printer accompanied with the progress in the technology such as digitalization of exposing system and minimizing of the toner diameter. Moreover, a technology capable of forming a full color image is developed in which toner images are respectively formed on plural photoreceptor drums and the formed toner images are piled by primarily transferred onto an intermediate transferring member, and the image formed on the intermediate transferring member is secondarily transferred onto image support material. As above-mentioned, the formation of full color image requiring high resolving power such as that of the photographic image can be realized by such the image forming method additionally to the usual silver halide photography or printing technology.

A glossy image is often required in a photographic image of poster; however, white background area with low glossiness of the image formed by the toner is obtained sometimes even though the images area fixed on the support such as a paper sheet has some degree of glossiness. Such the unbalance in the glossiness in the finished image causes degradation in the image quality of the printed matter; therefore countermeasure to such the phenomenon is demanded.

On such the background, a technique is investigated, by which the image formation is carried out by using a toner constituted by omitting colorant from the usual color toner, so called as a clear toner, for preventing the formation of irregularity in the glossiness on the image. In concrete, a technique is disclosed, in which the clear toner is uniformly provided on the whole surface of the support carrying the image and heated and cooled to form a clear toner layer on the whole surface of the image for preparing a printed matter having uniform glossiness on the whole surface of the image (cf. Patent Document 1, for example).

Moreover, a technique is disclosed in which a clear toner layer is formed on the image formed by a printer by using a high glossiness providing apparatus to provide a glossy printed matter (cf. Patent Documents 2 and 3, for example).

Such the apparatus is connected with a printer such as an electrophotographic printer and the clear toner layer is entirely formed on the surface of the image formed by the printer, and the clear toner layer is melted by heating the layer in a state of contacting with a belt of the glossing apparatus. And then the clear toner layer is solidified by cooling while contacting with the belt. The printed matter is naturally released from the belt after solidifying of the clear toner layer; thus the printed matter having uniform glossy surface is finished.

Furthermore, an image forming technique is known, in which difference of the physical properties between the colored toner and the clear toner is noted and the difference between the particle diameter of the colored toner and that of the clear toner is specified to obtaining the uniform glossiness (cf. Patent Document 4, for example).

By using clear toner disclosed above, a printed matter having some extent of glossiness on an image can be obtained.

### PATENT DOCUMENT

Patent Document 1: Unexamined Japanese Patent Application (hereinafter, referred to as JP-A) No. H11-007174

Patent Document 2: JP-A 2002-341619

Patent Document 3: JP-A 2004-258537

Patent Document 4: JP-A 2007-140037

### SUMMARY OF THE INVENTION

However, when a printed mater is formed by an image forming technique using clear toner disclosed above, there are challenges such that a printed matter cannot be released from a heating roll or belt; or that a printed matter cannot have high glossiness (for example, glossiness 80 or more by measuring angle of 20°) after conveying through an oil-less heating and pressuring member and a cooling and releasing member of a high glossiness providing apparatus.

An object of the present invention is to provide a method for forming a printed mater in which a printed matter can be released from a heating roll or belt; or that a printed matter can have high glossiness (for example, glossiness 80 or more by measuring angle of 20°) after conveying through an oil-less heating and pressuring member and a cooling and releasing member of high glossiness providing apparatus.

The above object has been attained by the following constitutions:

1. A method for forming a high glossy printed matter comprising at least steps of

(a) heating and melting a clear toner supplied on an image support material,

(b) bringing the image support material at a side in which the a clear toner is supplied into contact with a belt, and cooling the transparent toner while contacting with the belt, and

(c) releasing the image support material from the belt,

wherein the clear toner comprises at least a resin and a wax, a glass transition point (Tg) of the resin is not less than 30° C. and not more than 70° C., and a crystallization temperature (Tc) of the wax is not less than 60° C. and not more than 99° C.

2. The method for forming the high glossy printed matter of item 1, wherein Tg and Tc satisfies the following relation: (Tc−Tg)≧15° C., wherein Tg represents a glass transition point (Tg) of the resin and Tc represents a crystallization temperature (Tc) of the wax.

3. The method for forming the high glossy printed matter of item 1 or 2, wherein the resin is obtained by polymerizing at least styrene monomer, butyl acrylate monomer and methyl methacrylate monomer, and a content of the wax is not less than 4% by mass and not more than 17% by mass based on a total clear toner.

4. The method for forming the high glossy printed matter of any one of items 1 to 3, wherein Tg, Tc, T1 and T2 satisfies the following relation: (T1−Tc)≧70° C., and (Tg−T2)≧−25° C., wherein Tg represents a glass transition point (Tg) of the resin, Tc represents a crystallization temperature (Tc) of the wax, T1 represents a surface temperature of a cooling and releasing belt just before the image support material being nipped with the heating and pressuring member, and T2 represents a surface temperature of the high glossy clear toner layer just after the image support material being released from the cooling and releasing belt of the cooling and releasing member.

5. The method for forming the high glossy printed matter of item 1 comprising further step of heating and pressuring a clear toner particle layer before the step of (a).

The method for forming a printed mater of the present invention made it possible to provide a printed matter employing a clear toner which has high glossiness (for example, glossiness 80 or more by measuring angle of 20°) after conveying through an oil-less heating and pressuring member and a cooling and releasing member of high glossiness providing apparatus.

### BRIEF DESCRIPTION OF THE DRAWINGS

FIG. 1: A schematic diagram of an example of a method for forming a glossy printed matter via steps of forming a clear toner particle layer on surface of the image support material carrying a toner image, and forming a glossy clear toner layer by heating-pressuring the clear toner particle layer.

FIG. 2: A schematic view of an example of an electrophotographic image forming apparatus for forming a glossy printed matter which can form a clear toner particle layer at the same time as forming a toner image, followed by forming a glossy clear toner layer via melting the clear toner particle layer employing a heating/pressurizing fixation unit.

FIG. 3: A schematic view of an example of a heating/pressurizing fixation unit employing an oil-less heating roll and a pressuring roll which does not comprise a member for coating silicone oil.

FIG. 4: A schematic view of an example of a heating/pressurizing fixation unit employing an oil-less heating roll and a pressuring belt which does not comprise a member for coating silicone oil.

FIG. 5: A schematic view of an example of a heating/pressurizing fixation unit employing an oil-less heating belt and a pressuring roll which does not comprise a member for coating silicone oil.

FIG. 6: A schematic view of an example of a heating/pressurizing fixation unit employing an oil-less heating belt and a pressuring belt which does not comprise a member for coating silicone oil.

FIG. 7: A schematic diagram of an example of a method for forming a high glossy printed matter via employing a glossy printed matter having a glossy toner layer through a high glossiness providing apparatus.

FIG. 8: A schematic view of an example of a high glossiness providing apparatus for forming a high glossy printed matter which does not comprise a member for coating silicone oil.

FIG. 9: A schematic diagram showing an example of an apparatus in which the high glossiness providing apparatus of FIG. 8 is installed in the electrophotographic image forming apparatus of FIG. 2. FIG. 10: A schematic diagram showing an example of an apparatus in which the high glossiness providing apparatus of FIG. 8 is installed instead of the heating/pressurizing fixation unit in the electrophotographic image forming apparatus of FIG. 2.

### DETAILED DESCRIPTION OF THE INVENTION

The inventors of the present invention conducted investigations relates to a method for forming a high glossy printed matter, in which a printed matter can be released from a heating roll or belt; and a printed matter can have high glossiness (for example, glossiness 80 or more by measuring angle of 20°) even after conveying through an oil-less heating and pressuring member and a cooling and releasing member of high glossiness providing apparatus.

When a glossy clear toner layer is formed by a clear toner particle layer through an oil-les heating/pressurizing fixation unit employing a clear toner proposed above, there is challenge such that an image support wraps around a heating roll or belt of the heating/pressurizing fixation unit. For the purpose of preventing this wrapping, oil (for example, silicone oil) is coated on a healing roll or belt of the heating/pressurizing fixation unit.

However, when a glossy printed matter is formed through a heating/pressurizing fixation unit coated by oil, oil is partially bleeding out on the surface of the glossy clear toner layer and causes irregularity in the glossiness, resulting in difficulty to have glossy printed matter having uniform glossiness.

For preventing wrapping even when using an oil-less heating/pressurizing fixation unit without coating oil, wax is required to be incorporated in clear toner particles.

The wax incorporated in the clear toner particles is melt at heating/pressurizing step by heating/pressurizing fixation unit, and crystallized to remain partially on the surface at cooling step, whereby fine and formed deep asperity on the surface of the crystallized wax.

The inventors of the present invention presume that the deep asperity formed on the surface of the crystallized wax causes diffuse reflection and lowers glossiness.

The inventors of the present invention investigated a clear toner for forming a glossy printed matter even by using an oil-less heating and pressuring member.

As a result of various investigation, it was found that above object was achieved by using a clear toner at least comprising a wax and a resin, wherein a glass transition point (Tg) of the resin is not less than 30° C. and not more than 70° C., and a crystallization temperature (Tc) of the wax is not less than 60° C. and not more than 99° C.

Further, it was found that by using a wax having a crystallization temperature (Tc) of 15° C. or more higher than a glass transition point (Tg) of the resin constituting the clear toner, a crystallization of the wax precedes a solidification of the resin at the cooling step by high glossiness providing apparatus, thereby the glossy printed matter can be more easily obtained.

The wax melted out on the surface of the clear toner at heating/pressuring step is crystallized to form asperity, but this asperity is filled by the resin solidified later, whereby the asperity of the wax exposed on the image surface can be reduced. As a result, decrease of glossiness can be inhibited even by using wax.

Further, heating/pressuring via a heating and pressuring member in a high glossiness providing apparatus promotes immerse of wax in the clear toner layer, resulting in having the high glossy printed matter.

The following terms are intended to have the following general meanings as they are used herein:

### <Printed Matter>

“Printed matter” of the present invention refers to as one in which a clear toner layer is formed wholly or partially on the image on the image support material.

### <Image Support Material>

“Image support material” of the present invention refers to as a support which is used for forming an image and a clear toner layer.

As “Image support material” of the present invention, well-known in the art may be employable without being restricted thereto, as long as it enables to form a toner image by using the electrophotographic image forming apparatus with oil-less heating and pressuring member and to support a clear toner layer on the toner image.

Well-known image support materials include thin to thick plain paper, coated printing paper such as high-quality paper, art paper or coat paper, commercially available postcard paper and plastic film for OHP.

### <Image>

In the present invention, the “image” is one having the state of medium capable of informing information such as images of characters or pictures to users. Namely, the “image” includes not only the area of the image support on which toner or ink exists but the area so called as white background on which no toner nor ink exists, and in the state capable of informing information to the users. The “image” of the invention includes both of “image area” which is formed by toner or ink and “non-image area” on which no toner nor ink exists.

In the present invention, the method for forming the image before the formation of the clear toner layer is not specifically limited, and ones prepared by usual image forming method such as electrophotographic system, printing work, ink-jet system, or silver halide photographic system can be applied.

### <Clear Toner>

The clear toner employed in the present invention means toner particles comprising at least a resin and a wax, and generally colorless and transparent.

In the present invention, the clear toner includes toner particles even having a slight color or slightly decreasing transparency depending on species and amount of a resin, wax and an external additive.

In another words, “clear tone” means toner particles containing at least a resin and a wax and no colorant which displays color by an action of light absorption or light scattering such as color pigment, color dye black carbon particles, or black magnetic powder.

In the present invention, the clear toner means aggregate of clear toner particles.

### <Clear Toner Particle Layer>

“Clear toner particle layer” of the present invention referred to as a layer comprising clear toner particles which are formed by dear toner supplied on the image support material from a clear toner particle layer forming member of an electrophotographic image forming apparatus.

### <Glossy Clear Toner Layer>

“Glossy clear toner layer” of the present invention referred to as a layer exhibiting glossiness which is formed by heat-melting the clear toner particle layer via heating/pressurizing fixation unit.

Herein, the glossy clear toner layer is preferable formed on the image support material by using clear toner of not less than 2 g/m² and not more than 15 g/m².

When the layer is formed by a content of clear toner in the above range, glossy printed matter can be easily formed.

### <High Glossy Clear Toner Layer>

“High glossy clear toner layer” of the present invention referred to as a layer having more glossiness which is formed by heating/pressuring treatment of the glossy clear toner layer on the image support material through high glossiness providing apparatus.

### <Glossiness of Printed Matter>

The term of glossiness is quantification of the degree of reflection at the surface of the printed matter when light is irradiated on the printed matter under a predetermined condition.

Glossiness of printed matter can be determined by the following procedure.

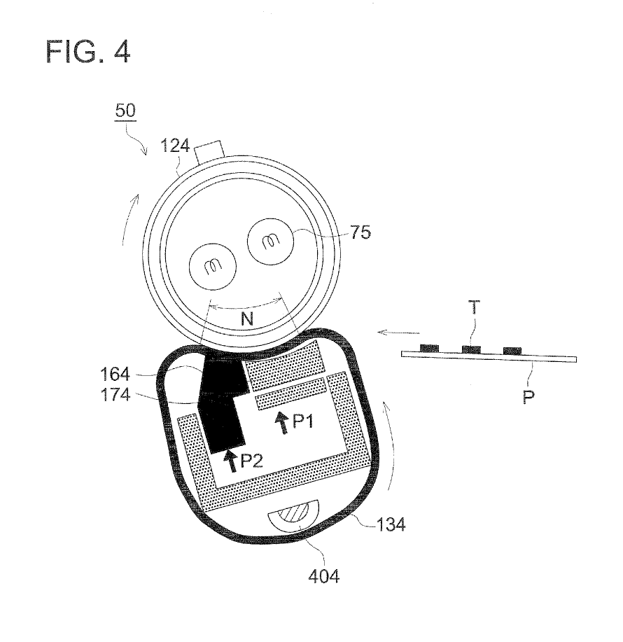

Glossiness of the printed matter which is formed by using a heating/pressurizing fixation unit of an electrophotographic image forming apparatus (for example, heating/pressurizing fixation unit shown in FIG. 4) and a high glossiness providing apparatus (for example, high glossiness providing apparatus shown in FIG. 8) is determined by a glossimeter GMX-203, manufactured by Murakami Color Research Laboratory Co., Ltd., according to JIS Z8741 1997. Glossiness is determined by averaging the values of measured 10 points.

Herein, in case of the printed matter having a glossy clear toner layer formed by using a heating/pressurizing fixation unit of an electrophotographic image forming apparatus, glossiness of the printed matter is determined with measuring angle of incidence of 75°, and in case of the printed matter having a high glossy clear toner layer formed by using a high glossiness providing apparatus, glossiness of the printed matter is determined with measuring angle of incidence of 20° which enable to distinguish a difference of glossiness clearly.

The present invention and the components thereof will now be detailed.

### <<Clear Toner>>

Clear toner of the present invention comprises at least a resin having specific glass transition point and a wax having specific crystallization temperature. In order to preventing wrapping to the heating roll or belt of the oil-less heating/pressurizing fixation unit while ensuring glossiness, clear toner of the present invention is preferable one (for example, core-shell structure) which comprises a wax at a center of toner particle (for example, core part) and a layer without wax at outer thereof (for example, shell layer).

### (Glass Transition Point of Resin)

In view of glossiness, fixation, and heat resistance during storage, resin constituting a clear toner has a glass transition point (Tg) of not less than 30° C. and not more than 70° C., preferably of not less than 45° C. and not more than 70° C.

The glass transition point of the resin is determined employing a differential scanning calorimeter (DSC). An intersection point of a base line and a derivative curve of endothermic peak is designated as the glass transition point. Specifically, by using a differential scanning calorimeter, a sample is heated to 100° C., kept for 3 minutes at that temperature, and cooled to a mom temperature with a temperature decreasing rate of 10° C./min. Subsequently, when this sample is measured under the measuring conditions of a temperature increasing rate of 10° C./min, an intersection point of an extension of a base line under glass transition point and a tangent showing the maximum inclination between the initial rising position of the first endothermic peak and the peak top is designated as a glass transition point. As a differential scanning calorimeter, “DSC-7” (produced by PERKIN ELMER, Inc.) may be employed.

Glass transition point (Tg) of a resin constituting clear toner is determined according to the method described above by using a separated resin from a toner by dissolving a toner in tetrahydrofuran and separating the resin.

### (Crystalization Temperature of Wax)

In view of glossiness, wrapping at fixation, and heat resistance during storage, wax constituting a clear toner has a crystallization temperature (Tc) of not less than 60° C. and not more than 99° C., preferably of not less than 60° C. and not more than 90° C.

Crystallization temperature (Tc) of wax can be determined by using “DSC-7 differential scanning calorimeter” (produced by PERKIN ELMER, Inc.) and a thermal analyzer controller (TAC7/DX, produced by PERKIN ELMER, Inc.).

Specifically, 4.5-5.0 mg clear toner sample is precisely weighed to two places of decimals and encapsulated in an aluminum sample pan to be set a sample holder of differential scanning calorimeter DSC-7. An empty aluminum pan is used for the reference measurement. Subsequently, heating-cooling-heating temperature control is conducted under the measuring conditions of a temperature increasing rate of 10° C./min and a temperature decreasing rate of 10° C./min in the measurement temperature range of 0-200° C. to obtain data during the second heating cycle. The peak top is designated as a crystallization temperature (Tc) of wax.

Crystallization temperature (Tc) of wax is determined by measuring clear toner directly according to the above method.

### (Volume-Based Median Particle Diameter (D₅₀) of Clear Toner)

In view of forming glossy clear toner layer, volume-based median particle diameter (D₅₀) of clear toner is preferable 4-12 μm.

The above-described volume-based median particle diameter (D₅₀) of clear toner can be measured and calculated by using COULTER MULTISIZER 3 (manufactured by BECKMAN COULTER Inc.) with a 100 μm aperture diameter for a clear toner having volume of 2.0-60 μm.

Materials constituting clear toner will now specifically be described.

Clear toner employable in the present invention comprises at least a resin and a wax.

Content of wax is preferable not less than 4% by mass and not more than 17% by mass, more preferable not less than 4% by mass and not more than 10% by mass based on the total mass of clear toner. In case of content of wax being in the above range, wrapping is effectively prevented and it enables to form a glossy printed matter easily.

### (Wax)

Waxes employable to the present invention include Electrol WEP-2 (manufactured by NOF Corporation), the crystallization temperature of 60.0° C.; Electrol WEP-3 (manufactured by NOF Corporation), the crystallization temperature of 63.5° C.; Electrol WEP-4 (manufactured by NOF Corporation), the crystallization temperature of 64.4° C.; Electrol WEP-5 (manufactured by NOF Corporation), the crystallization temperature of 67.9° C.; WBM-1 (manufactured by NOF Corporation), the crystallization temperature of 64.0° C.; HNP-11 (manufactured by NIPPON SEIRO CO., LTD.), the crystallization temperature of 62.7° C.; HNP-51 (manufactured by NIPPON SEIRO CO., LTD.), the crystallization temperature of 72.9° C.; HNP-0190 (manufactured by NIPPON SEIRO CO., LTD.), the crystallization temperature of 81.5° C.; L-9622 (manufactured by Riken Vitamin Co., Ltd.), the crystallization temperature of 66.0° C.; Hi-Mic-1090 (manufactured by NIPPON SEIRO CO., LTD.), the crystallization temperature of 75.0° C.; FNP-0090 (manufactured by NIPPON SEIRO CO., LTD.), the crystallization temperature of 85.5° C.; FNP-0085 (manufactured by NIPPON SEIRO CO., LTD.), the crystallization temperature of 66.1° C.; and FT-100 (manufactured by NIPPON SEIRO CO., LTD.), the crystallization temperature of 94.4.

For comparison, the following waxes were employed: BE-205 (manufactured by NIPPON SEIKO CO., LTD.), the crystallization temperature of 57.0° C.; and MDP7000 (manufactured by NIPPON SEIRO CO., LTD.), the crystallization temperature of 110.0° C.

### <Resin>

In view of fixing property by heating/pressurizing fixation unit, the central portion of the clear toner (core portion) is preferably prepared by employing styrene-acryl based resin having the glass transition point described above.

Practical examples of styrene monomer and acrylic acid ester monomer usable for preparing styrene-acryl based resin are listed. The styrene monomer and acrylic acid ester monomer usable for the present invention is not limited to those listed below.

Specific examples of styrene monomer include: styrene, o-methylstyrene, m-methylstyrene, p-methylstyrene, α-methylstyrene, p-phenylstyrene, p-ethylstyrene, 2,4-dimethylstyrene, p-t-butylstyrene, p-n-hexylstyrene, p-n-octylstyrene, p-n-nonylstyrene, p-n-decylstyrene and p-n-dodecylstyrene.

Representative examples of acrylic acid ester monomer include acrylic acid ester monomer and methacrylic acid ester monomer listed below. Specific examples of acrylic acid ester monomer include: methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate and phenyl acrylate. Specific examples of methacrylic acid ester monomer include: methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate and dimethylaminoethyl methacrylate.

These acrylic acid ester monomer or methacrylic acid ester monomer may be employed individually or in combinations of at least two types. Namely, employable are all cases such as copolymer of styrene monomer and 2 or more acrylic acid ester monomers, copolymer of styrene monomer and 2 or more methacrylic acid ester monomers, or copolymer of styrene monomer in combination with acrylic acid ester monomer and methacrylic acid ester monomer.

As for a resin constituting an outer portion of the clear toner (shell layer), employable are the same styrene-acrylic based resins as the resin constituting the central portion (core portion). In view of heat resistance during storage, a resin constituting an outer portion of the clear toner (shell layer) has preferably higher glass transition point than that of the resin constituting the central portion.

A preparation method of the clear toner of the invention is described

### <<Preparation of Clear Toner>>

Various methods may be preferably employed for method for preparing clear toner used in the present invention. Clear toner having core/shell structure is formed via the following steps: resin particles for a core are allowed to coagulate to form core particles and resin particles for a shell are fed thereto to be allowed to form a shell onto the core particle surface.

A method for preparing clear toner will now be specifically described with the reference to examples.

For example, the clear toner of the present invention is manufactured via the following steps: (1) a step of forming a dispersion of resin particles for core via polymerization of polymerizable monomer in a mixture solution of polymerizable monomer and wax, (2) a step of forming a dispersion of resin particles for shell via polymerization of the polymerizable monomer, (3) a step of a dispersion of resin particles for core via coagulation/fusion of the core resin particles in an aqueous medium, (4) a step of arranging shape of core particles via ripening by heat energy, (5) a step of forming particles having core/shell structure via feeding a dispersion of resin particles for a shell into a dispersion of resin particles for core and via coagulation/fusion of the shell resin particles onto the core particle surface, (6) a step of arranging shape of particles having core/shell structure via ripening particles having core/shell structure by heat energy, (7) a step of forming washed particles via cooling a particles dispersion having core/shell structure with arranged shape, via solid/liquid separation from a particle dispersion and via washing to remove such as attached surfactant from particles, (8) a step of drying the washed particles, and (9) a step of addition of external additives into the dried particles as appropriate.

In preparation method of a clear toner, first, resin particles for a core are allowed to coagulate and fuse to form core particles and subsequently, resin particles to form a shell are fed thereto to be allowed to coagulate and fuse onto the core particle surface. Thus, the coagulation/fusion step is conducted two-stepwise to prepare particles of core/shell structure.

Clear toner employed for the present invention preferably has thin and uniform thickness of the shell layer.

Subsequently, surfactant, polymerization initiator and external additives employed for forming clear toner of the present invention will be described.

### (Surfactant)

In order to conduct polymerization by using the foregoing polymerizable monomer, oil droplet dispersion should be carried out in an aqueous medium employing a surfactant. The surfactant usable in this case is not specifically limited, but preferred examples include the following ionic surfactants.

Examples of ionic surfactants include sulfonates (for example, sodium dodecylbenzenesulfonate, sodium aryl alkyl polyethersulfonate, sodium 3,3-disulfondiphenylurea-4,4-diazo-bis-amino-8-naphthol-6-sulfonate, sodium ortho-caboxybenzene-azo-dimethylaniline, 2,2,5,5-tetramethyl-triphenylmethane-4 and 4-diazo-bis-β-naphthol-6-sulfonate); sulfate esters (for example, sodium dodecylsulfate; sodium tetradodecylsulfate, sodium pentadodecylsulfate and sodium octylsulfate); and fatty acid salts (for example, sodium oleate, sodium laureate, sodium caprate, sodium caprylate, sodium caproate, potassium stearate and calcium oleate).

Further, nonionic surfactants are also usable. Preferred examples thereof include polyethylene oxide, polypropylene oxide, a combination of polypropylene oxide and polyethylene oxide, an ester of polyethylene glycol and a higher fatty acid, alkylphenol polyethylene oxide, ester of a higher fatty acid and polyethylene glycol, ester of a higher fatty acid and polypropylene oxide, polyoxyethylene alkylether, and sorbitan ester.

### (Polymerization Initiator)

As the resin constituting core and shell particles of the present invention, preferably employed is a styrene-acryl based copolymer which is formed by radical polymerization of styrene monomer and acrylic acid ester monomer. In case of forming styrene-acryl based copolymer, well-known oil-soluble polymerization initiators or water-soluble polymerization initiators may be usable. Specific examples of oil-soluble polymerization initiators include azo or diazo based polymerization initiators and peroxide based polymerization initiators.

### (External Additive)

The kinds of external additives are not specifically limited, and examples thereof include inorganic or organic particles and a lubricant as described below. Preferred examples of inorganic particles include inorganic oxide particles such as silica, titania, and alumina As the inorganic particles, those having been subjected to a hydrophobilization treatment may be preferably used.

Content of external additives in clear toner is preferable not less than 0.1% by mass and not more than 5.0% by mass, more preferable 0.5% by mass and not more than 4.0% by mass. Further, external additives can be used in combination of various kinds thereof.

### <<Developer>>

The clear toner is usable as a single-component developer or as a two-component developer. In case of using as a two-component developer in mixing with carrier, commonly known materials typified by iron, ferrite and magnetite are usable for magnetic particles containing iron in carrier, but specifically preferable are ferrite particles or magnetite particles. The volume average diameter of the above-described magnetic particles is preferably not less than 15 μm and not more than 100 μm, and more preferably not less than 20 μm and not more than 80 μm.

The volume average diameter of the carrier can be measured employing a laser diffraction type particle size distribution measurement apparatus “HELOS”, produced by SYMPATEC Corp.

As the carrier, a coating carrier in which magnetic particles are coated by a resin, or a resin dispersion type carrier in which magnetic particles are dispersed in a resin is preferable. The coating resin composition is not specifically limited, but usable examples thereof include olefin based resin, styrene based resin, styrene-acryl based resin, silicone based resin, ester resin and fluorine-containing polymer resin. Resins used for the resin dispersion type carrier are not specifically limited, and those commonly known are usable, such as a styrene-acryl based resin, a polyester resin, a fluororesin and a phenol resin.

A mixed ratio of clear toner to carrier is preferable in the range of from Carrier : Clear toner=1:1 to Carrier:Clear toner=50:1 based on a ratio by mass.<<Method for forming Printed matter>>

### <Method for Forming Glossy Printed Matter>

As a method for forming glossy printed matter employing clear toner of the present invention, listed is a method in which a clear toner particle layer is formed by supplying clear toner on whole surface of an image support material which has a toner image formed via an electrophotographic image forming apparatus, thereafter the clear toner particle layer is heated/ pressured via heating/pressurizing fixation unit to form glossy printed matter.

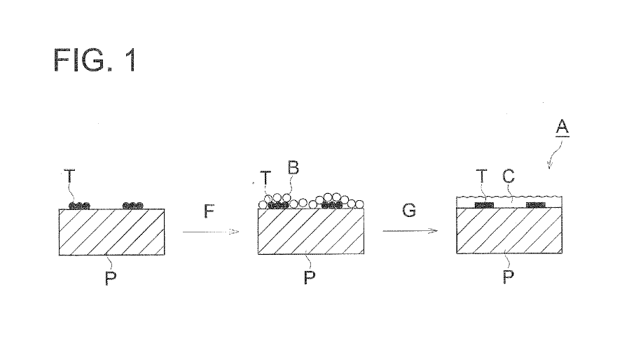

FIG. 1 is a schematic diagram of an example of a method for forming a glossy printed matter via steps of forming a clear toner particle layer on surface of the image support material carrying a toner image, and forming a glossy clear toner layer by heating-pressuring the clear toner particle layer.

FIG. 1, P represents an image support material, T represents a toner image, A represents a glossy printed matter, B represents a clear toner particle layer, C represents a glossy clear toner layer, F represents a step of forming a clear toner particle layer, and G represents a glossy clear toner layer.

A method for forming a glossy printed matter shown in FIG. 1 is a method in which, at first, in a step F of forming a clear toner particle layer, a toner image T is formed on an image support material P by using an electrophotographic image forming apparatus; thereafter, a clear toner particle layer B is formed on the image support material P, then, in a step G of forming a glossy clear toner layer, the clear toner particle layer is heated/ pressured via heating/pressurizing fixation unit to form glossy printed matter A.

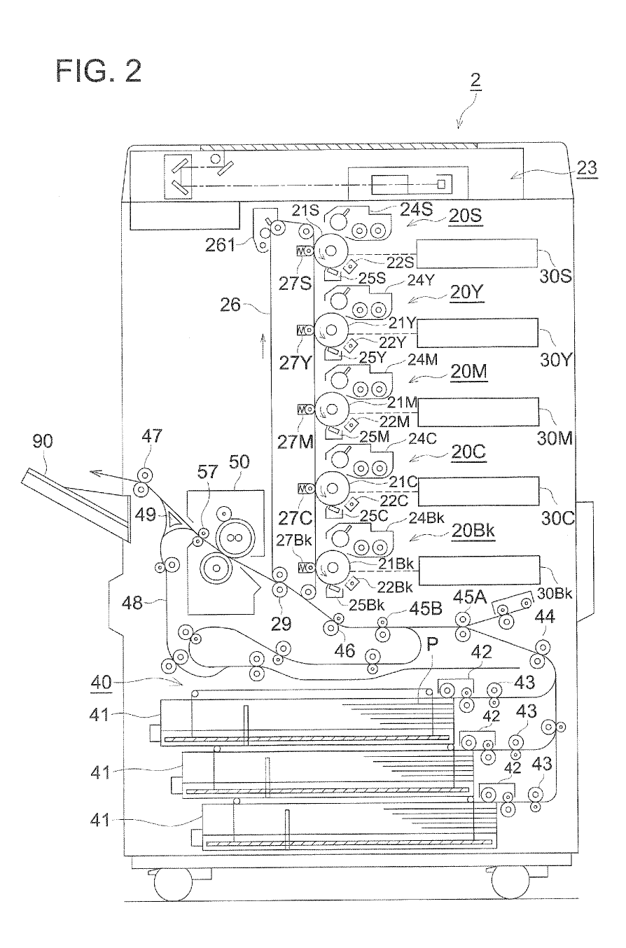

FIG. 2 is a schematic view of an example of an electrophotographic image forming apparatus for forming a glossy printed matter which can form a clear toner particle layer at the same time as forming a toner image, followed by forming a glossy clear toner layer via melting the clear toner particle layer employing a heating/pressurizing fixation unit.

Image forming device 2 shown in FIG. 2 is commonly called as a tandem type color image forming device and contains clear toner layer forming unit 20S, a plurality of toner image forming units 20Y, 20M, 20C and 20Bk, intermediate transfer belt 26, sheet feeder 40 and heating/pressurizing fixation unit 50.

Image reading device 23 is placed on the upper part of electrophotographic image forming apparatus 2. A manuscript placed on a manuscript holder is image-scanning-exposed to light emitted by an optical system of a manuscript image-scanning exposure device in image reading device 23 to read the image in a line image sensor. The analog signals photoelectrically converted by the line image sensor are input to light exposure devices 30S, 30Y, 30M, 30C and 30Bk, after conducting analog processing, A/D conversion, a shading correction and image compression processing in a control section.

In the present invention, in naming a component generically, the reference numerals in which alphabet subscript is omitted are used, and in pointing out discrete components, the reference numerals which is attached with the subscript of S (clear toner), Y (yellow), M (magenta), C (cyan), and Bk (black) are used.

In electrophotographic image forming apparatus 2 shown in FIG. 2, there are provided with clear toner particle layer forming unit 20S which forms a clear toner particle layer all over the image support material via intermediate transfer belt 26, yellow image forming unit 20Y which performs yellow toner image formation, magenta image forming unit 20M which performs magenta toner image formation, cyan image forming unit 20C which performs cyan toner image formation, and black image forming unit 20Bk which performs black toner image formation. Each toner image forming unit 20 contains a charging electrode 22 (22S, 22Y, 22M, 22C and 22Bk), an exposing member 30 (30S, 30Y, 30M, 30C, 30Bk), a developing member 24 and a cleaning member 25 (25S, 25Y, 25M, 25C, 25Bk) each located around a drum shaped photoreceptor 21 (21S, 21Y, 21M, 21C, 21Bk) as an image carrier.

Photoreceptor 21 contains an organic photoreceptor in which a photoreceptor layer containing a resin in which an organic photoconductor is incorporated is formed on a peripheral surface of a drum shaped metal support, which is placed extending toward the width direction of image support material P (a direction perpendicular to the paper sheet in FIG. 2). As a resin for the photoreceptor layer formation, a well-known resin forming a photoreceptor layer such as polycarbonate is used. In the embodiment shown in FIG. 2, an example in which a drum shaped photoreceptor 21 is used, however, the photoreceptor is not limited thereto and a belt shaped photoreceptor may be used. Developing member 24 each include a two-component developer containing each of a clear toner (S) according to the present invention, color toners of each color such as a yellow toner (Y), a magenta toner (M), a cyan toner (C), and a black toner (Bk), and a carver.

Intermediate transfer belt 26 which is an intermediate transfer medium is rotatably supported by a plurality of rolls. Intermediate transfer belt 26 is an endless belt exhibiting a volume resistance of preferably 10⁶ to 10¹² Ω·cm. Intermediate transfer belt 26 may be formed by a well-known resin, for example, polycarbonate (PC), polyimide (PI), polyamideimide (PAI), polyvinylideine fluoride (PVDF), or a tetrafluoroethylene-ethylene copolymer (ETFE). The thickness of intermediate transfer belt 26 is preferably 50 to 200 μm.

The clear toner layer formed by clear toner layer forming unit 20S and each color image formed on each photoreceptor 21 (21S, 21Y, 21M, 21C, 21Bk) by each of toner image forming units 20Y, 20M, 20C and 20Bk is sequentially transferred on to intermediate transfer belt 26 employing each primary transfer roller 27 (27S, 27Y, 27M, 27C, and 27Bk) (primary transfer), whereby a clear toner layer and a combined full color image is formed. After the images are transferred, each photoreceptor of 21 (21S, 21Y, 21M, 21C and 21Bk) is subjected to cleaning by each cleaning member 25 (25S, 25Y, 25M, 25C, 25Bk) to remove residual toner.

Image support material P stored in storing member 41 (tray) in sheet feeder 40 is fed to first feeding member 42 and conveyed through feeing rolls 43, 44, 45A, 45B, and resist roll 46 (second feeding member) to secondary transfer roll 29, where the clear toner particle layer and the full color image are transferred (secondary transfer).

The three vertically arrayed storing members 41 in the lower portion of image forming device 2 were provided with the same number since these three members have almost the same structure. Also, the three vertically arrayed feeding members 42 were provided with the same number since the structures are almost the same. Storing members 41 and feeding members 42 in all are named as sheet feeder 40.

Image support material P on which has been transferred the clear toner layer and the full color image is held between heating roll and pressuring roll in heating/pressurizing fixation unit 50, and the clear toner and each toner are melted then solidified by the effects of heating and pressurizing. Thus, heating/pressurizing fixation unit 50 fixes the full color toner image on which the clear toner particle layer has been formed all over the image carrier on the image support material P. The image support material P is conveyed between a pair of conveying rolls 57, discharged through discharge rolls 47, and placed on a discharge tray 90 which is outside of the image forming device.

After transferring the clear toner particle layer and the full color toner image onto image support material P using secondary transfer roll 29 and separating image support material P by curvature separation, the residual toner on intermediate transfer belt 26 is removed by cleaning member 261 for intermediate transfer belt.

As heating/pressurizing fixation unit, employable are oil-less types which does not comprise a member for coating silicone oil and applied in electrophotographic image forming apparatus such as (1) heating/pressurizing fixation unit comprising heating roll and pressuring roll, (2) heating/pressurizing fixation unit comprising heating roll and pressuring belt, (3) heating/pressurizing fixation unit comprising heating belt and pressuring roll, and (4) heating/pressurizing fixation unit comprising heating belt and pressuring belt.

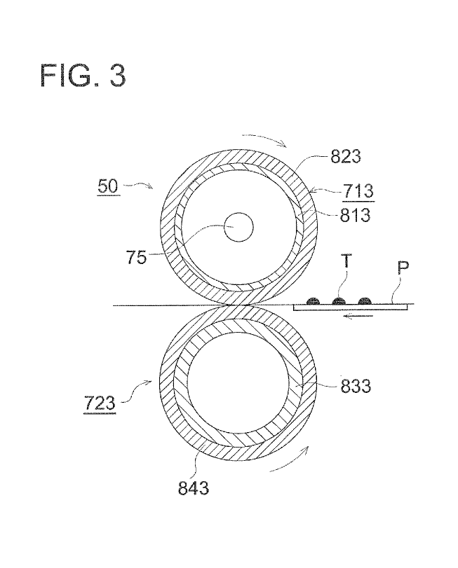

FIG. 3 is a schematic view of example of a heating/pressurizing fixation unit employing an oil-less heating roll and a pressuring roll which does not comprise a member for coating silicone oil.

Heating/pressurizing fixation unit 50 shown in FIG. 3 comprises heating roll 713 in contact with pressuring roll 723. Herein, in FIG. 3, T is toner image formed on image support material P.

Heating roll 713 has covering layer 823 comprising fluorine resin or elastic material lined onto the surface of core metal 813, and heating member 75 comprising linear heater is installed inside.

Core metal 813 comprises metal and has an inner diameter of 10-70 mm. Metal constituting core metal 813 is not specifically limited, but listed is metal such as iron, aluminum, and cupper or alloy thereof

Thickness of core metal 813 is 0.1-15 mm and is determined in view of balancing energy saving and strength. For example, thickness of core metal comprising aluminum is required to be 0.8 min, in order to keep the same strength as core metal comprising iron having 0.57 mm thickness.

As fluorine resin constituting surface of covering layer 823, exemplified are polytetrafluoro ethylene (PTFE) and tetrafluoro ethylene-perfluoro alkyl vinyl ether copolymer (PFA).

Thickness of covering layer 823 comprising fluorine resin is 10-500 μm, preferable 20-400 μm.

When thickness of covering layer 823 comprising fluorine resin is less than 10 μm, it is unable to fulfill enough function of covering layer and is difficult to ensure durability as heating/pressurizing fixation unit. On the contrary, when thickness exceeds 500 μm, since surface of covering layer tends to cause defect by paper dust, and toner adheres at the defects, whereby results in causing image staining.

As elastic material constituting surface of covering layer 823, preferred are silicone rubber exhibiting good heat resistance such as LTV, RTV and HTV or silicone sponge rubber.

Asker C hardness of elastic material constituting surface of covering layer 823 is less than 80°, preferable less than 60°.

Thickness of elastic material constituting surface of covering layer 823 is preferable 0.1-30 mm, more preferable 0.1-20 mm.

Halogen heater is preferably employed as heating member 75.

Pressuring roll 723 has covering layer 843 comprising elastic material lined onto the surface of core metal 833. Elastic material constituting surface of covering layer 843 is not specifically limited, but listed are various soft rubber such as urethane rubber and silicone rubber and sponge rubber. Silicone rubber and silicone sponge rubber exemplified one constituting covering layer 843 are preferably employed.

Thickness of covering layer 843 is preferable 0.1-30 mm, more preferable 0.1-20 mm. In heating roll 10 in heating/pressurizing fixation unit, surface temperature is preferable at 70-180° C. and line velocity is preferable 80-640 mm/sec. Further, nip width formed by heating roll and pressuring roll is set in 8-40 mm, preferably in 11-30 mm.

FIG. 4 is a schematic view of an example of a heating/pressurizing fixation unit employing an oil-less heating roll and a pressuring belt which does not comprise a member for coating silicone oil.

Main portion of heating/pressurizing fixation unit 50 shown in FIG. 4 is constituted by heating roll 124, pressuring belt 134, the pressure contact mechanism 164 with maximum nip pressure (nip pressure P2), the pressure contact mechanism 174 with weak nip pressure (nip pressure P1) which come in pressure contact with heating roll 124 via pressuring belt 134, and lubricant supply member 404. Herein, P represents image support material and T represents toner.

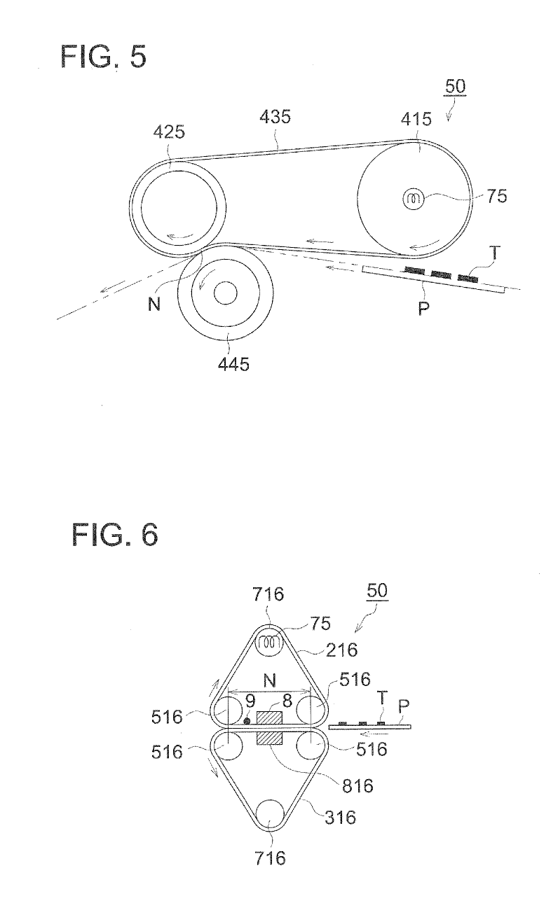

FIG. 5 is a schematic view of an example of a heating/pressurizing fixation unit employing an oil-less heating belt and a pressuring roll which does not comprise a member for coating silicone oil.

Heating/pressurizing fixation unit 50 comprises heating roll 415 with heat source 75 by halogen lamp, supporting roll 425 which is parallel provided at a position apart from the heating roll 415, endless belt 435 to be laid across in a tensioned condition between the heating roll 415 and the supporting roll 425, and opposed roll 445 which forms fixing nip portion N by pressuring to the support roll 425 via the fixing belt 435. Herein, P represents image support material and T represents toner.

FIG. 6 is a schematic view of a heating/pressurizing fixation unit employing an oil-less heating belt and a pressuring belt which does not comprise a member for coating silicone oil.

FIG. 6, 50 represents heating/pressurizing fixation unit, 216 represents heating belt, 316 represents pressuring belt, 75 represents heat source, 516 represents tension roll, 716 represents driving roll, 816 represents pressure contact member, N represents nipped portion, P represents image support material and T represents toner.

FIG. 6 has a constitution in which heating belt 216 is pressure contacted to pressuring belt 316 via tension roll 516 and pressure contact member 816, and heating belt 216 is heated via heat source 75 incorporated in driving roll 716.

### <Method for Forming High Glossy Printed Matter>

As a method for forming a high glossy printed matter, employed is a method in which high glossy printed matter is formed by further heating and pressuring the glossy printed matter having the glossy clear toner layer prepared above by using a high glossiness providing apparatus.

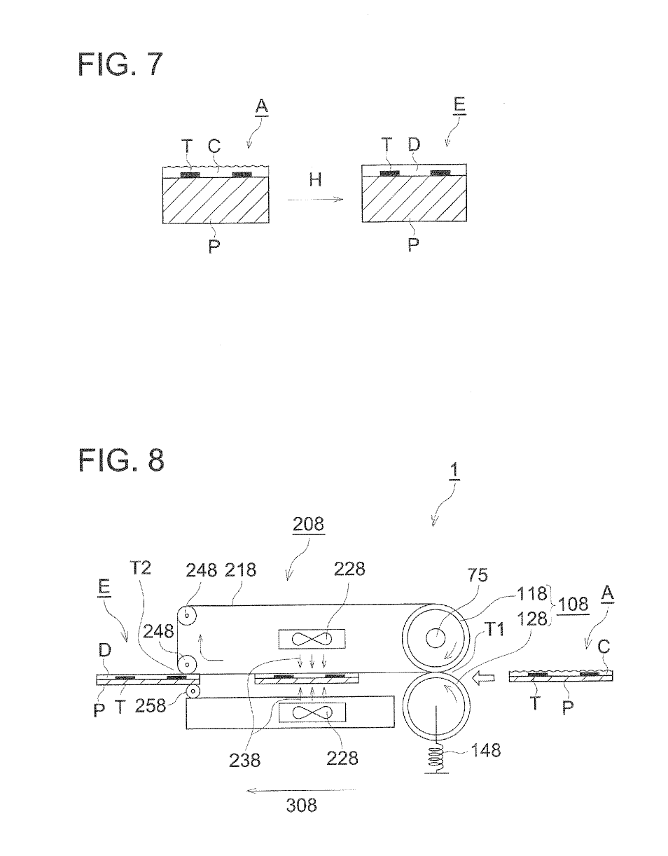

FIG. 7 is a schematic diagram of a method for forming a high glossy printed matter via employing a glossy printed matter having a glossy toner layer through a high glossiness providing apparatus.

In FIG. 7, P represents image support material, T represents toner, A represents glossy printed mtter, C represents glossy clear toner layer, D represents high glossy clear toner layer, E represents high glossy printed matter, and H represents a step for forming a high glossy printed matter.

In a method for forming high glossy printed matter shown in FIG. 7, in step H for forming a high glossy clear toner layer, a glossy printed matter A having a glossy clear toner layer is passed through a high glossiness providing apparatus to heat and pressure the surface of a glossy clear toner layer, followed by cooling a cooling and releasing to form a high glossy clear toner layer D and a high glossy printed matter E.

FIG. 8 is a schematic view of a high glossiness providing apparatus for forming a high glossy printed matter which does not comprise a member for coating silicone oil.

As well as in a high glossiness providing apparatus, preferred is to employ a high glossiness providing apparatus which does not comprise members for coating silicone oil, because silicone oil coated on heating roll or heating belt causes lowering of glossiness.

In FIG. 8, P represents image support material, T represents toner, C represents glossy clear toner layer, D represents high glossy clear toner layer, E represents high glossy printed matter, 1 represents high glossiness providing apparatus, 108 represents heating/pressuring portion, 118 represents heating roll, 128 represents pressuring roll, 75 represents heating source, 148 represents pressuring spring, 208 represents cooling/transferring portion, 218 represents cooling and releasing belt, 228 represent cooling fan, 238 represent cold air, 248 and 258 represent conveying rolls, 308 represents transferring direction of printed matter, T1 represents a surface temperature of the belt just before the image support material being nipped at the heating/pressuring portion, and T2 represents a surface temperature of the high glossy clear toner layer just after the image support material being released from the cooling and releasing belt.

The high glossiness providing apparatus 1 shown in FIG. 8 comprises a heating/pressuring portion 108 and a cooling/transferring portion 208. In heating/pressurizing member, glossy printed matter A is inserted between a heating roll 118 and pressuring roll 128 driven at a constant speed to be carried and clear toner layer C is heated and pressurized. Namely, the glossy clear toner layer C on the image support material P is melted by the heat supplied from heating/pressurizing member and then cooled to form the high glossy clear toner layer D, resulting in obtaining the high glossy printed matter E.

Inside of the heating roller, heating source 75 is incorporated. Pressuring spring is incorporated with pressuring roll 128. Further, inside of the pressuring roller 128, heating source 75 may be incorporated.

Nipping width between the heating roller and the pressuring roller is preferable 2-18 mm, more preferable 9-15 mm.

Nipping pressure between the heating roller and the pressure roller is preferable 100-1,000 kPa.

Heating roll has a structure in which an elastic layer containing, for example, a silicone rubber is coated on a surface of a metallic core made of for example, aluminum to have a predetermined outer diameter. In the inside of heating roll, for example, a 300 to 350 W halogen lamp is installed as a heat source to heat the heating roll from inside so that the surface temperature reaches the predetermined temperature

Pressurizing roll has a structure in which an elastic layer containing, for example, a silicone rubber is coated and covered by, for example, a tube of PFA (tetrafluoroethylene/perfluoroalkyl vinylether copolymer) as a separator layer, on a surface of a metallic core made of, for example, aluminum to have a predetermined outer diameter. Also in the inside of pressure roll, for example, a 300 to 350 W halogen lamp may be installed as a heat source to heat the pressure roll from inside so that the surface temperature reaches the predetermined temperature.

Cooling/transferring portion 208 will now be described. Cooling/transferring portion 208 is constituted by endless cooling and releasing belt 218 rotatably supported by heating roll 118 and a plurality of rolls 248 and cooling member 228.

The cooling and releasing belt member is hung by and rotatably supported by heating roll and plural rolls and is driven and moved at a predetermined speed by a drive source which is not illustrated.

Since the cooling and releasing belt member forms a contact surface with the melted clear toner surface and the image support P is conveyed via the melted clear toner surface, it can be produced with a material which possesses a certain extent of heat resistance and mechanical strength. Specifically, for example, heat-resistant film resins such as polyimide, polyether polyimide, PES (polyethersulfone) and PFA (tetrafluoro ethylenelperfluoroalkyl vinylether copolymer) are cited. It is preferable that, a release layer containing a fluorine containing resin such as PTFE (polytetrafluoroethylene) or PFA, or a silicon rubber is formed on at least a surface where the clear toner layer contacts of the abovementioned heat-resistant film resin.

The thickness of cooling and releasing belt member is not specifically limited if the image support material can be conveyed via a contact surface with the melted clear toner surface, and a belt member with a suitable thickness is usable. Specifically, the thickness of a heat-resistant film resin is preferably 20 to 80 μm, the thickness of a release layer is preferably 10 to 30 μm, and the total thickness is preferably 20 to 110 μm. Specific preferable example is an endless film made of polyimide having thickness of 80 μm, coated with silicone rubber layer of 30 μm thickness.

Next, cooling member will be described. The cooling member has cooling fan in the inside and on the downside of foregoing cooling and releasing belt member. Cold air from cooling fan forces to cool an image support material P forming clear toner layer in a state of conveying via cooling and releasing belt member 218.

The solidification of the clear toner layer of the image support material P under conveyance by the belt member is promoted by forced cooling by the abovementioned cooling fans, and the clear toner layer is fully cooled and hardened when the clear toner layer is conveyed near the end where conveying roll 258 is provided and where the high glossy printed matter E is separated from the belt member.

High glossiness providing apparatus is preferably set to satisfy the following relation, provided that T1 represents a surface temperature of the cooling and releasing belt just before the image support material being nipped with the heating and pressuring belt, and T2 represents a surface temperature of the clear toner layer just after the image support material being released from the cooling/releasing belt.

(T1−Tc)≧70° C.

Temperature difference between T1 and Tc being not less than 70° C. enables to promote immersing wax in clear toner layer as well as to enhance initial cooling efficiency.

(Tg−T2)>−25° C.

Temperature difference between T2 and Tg being not less than −25° C. enables to cool the resin, resulting in obtaining high glossy clear toner layer and further to prevent the wrapping of the image supporting material in the releasing step.

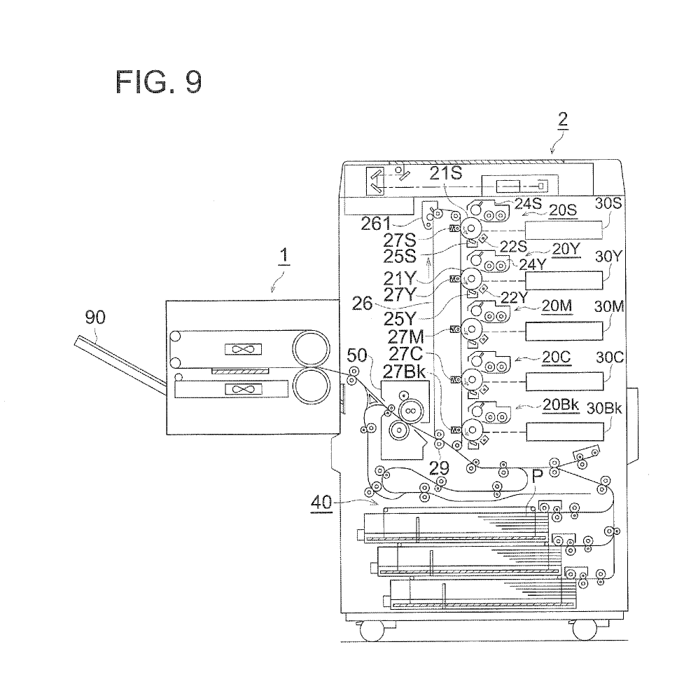

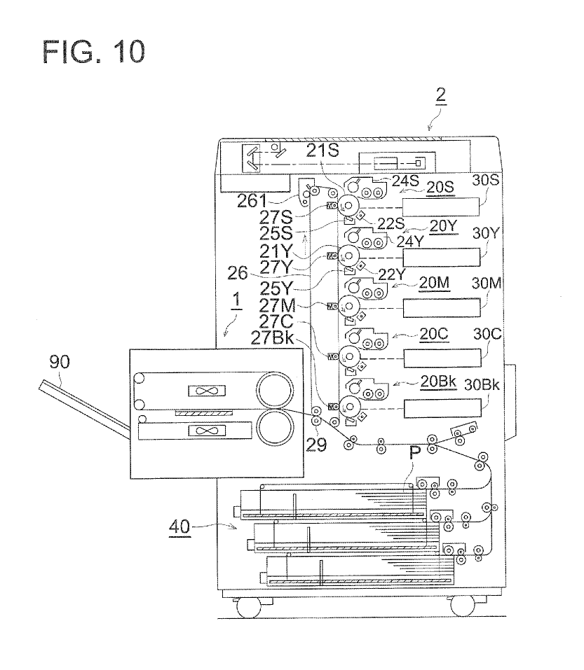

Herein, temperature T1 and T2 are measured via non-contact type thermometer. FIG. 9 is a schematic diagram showing an example of an apparatus in which the high glossiness providing apparatus of FIG. 8 is installed in the electrophotographic image forming apparatus of FIG. 2. The electrophotographic image forming apparatus shown in FIG. 9 has the high glossiness providing apparatus 1 in FIG. 8 at the position of discharging paper in the electrophotographic image forming apparatus 2 shown in FIG. 2. The image supporting material which has the glossy clear toner layer fixation treated by the heating/pressurizing fixation unit 50 built-in the electrophotographic image forming apparatus 2 shown in FIG. 2.

FIG. 10 is a schematic diagram showing an example of an apparatus in which the high glossiness providing apparatus of FIG. 8 is installed instead of the heating/pressurizing fixation unit in the electrophotographic image forming apparatus of FIG. 2.The electrophotographic image forming apparatus shown in FIG. 10 has the high glossiness providing apparatus 1 in FIG. 8 instead of the heating/pressurizing fixation unit 50 built-in the electrophotographic image forming apparatus 2 shown in FIG. 2. A high glossy clear toner layer can be formed via high glossiness providing apparatus by treating the clear toner particle layer formed on image supporting material P via secondary transferring roll 29. Since the electrophotographic image forming apparatus shown in FIG. 10 has the built-in high glossiness providing apparatus 1, whereby it is preferable in view of realizing small size apparatus.

The high glossy printed matter preparing by employing clear toner enables to apply uses for requiring high glossiness or surface resistance. Specifically, it is preferably applied for poster for outdoor use.

Further, a glossy printed matter applying glossy clear toner layer to a portion of the surface can form water-marked text because clear toner portion becomes transparent.

### EXAMPLES

The embodiments of the invention are concretely described by means of Example. The invention is not limited to these.<<Preparation of Clear toner>>

Clear toner was prepared by the procedure described as following.

### (Preparation of Resin Particles Dispersion for Core 1) (First Step Polymerization)

Into a reaction vessel equipped with a mechanical stirrer, a temperature sensor, a condenser, and a nitrogen gas directing tube, was loaded solution in which 3.0 parts by mass of sodium polyoxyethylene-2-dodecylether sulfate was dissolved in 1,340 parts by mass of ion exchanged water and heated to 80° C. Thereafter, added was polymerizable monomer solution in which 255 parts by mass of styrene (St), 114 parts by mass of n-butyl acrylate (BA), 21 parts of methacrylic acid (MAA), 10.5 parts of n-octyl mercaptan (n-OM), and 101.0 parts of Electrol WEP-3 were dissolved at 80° C. After that it was subjected to mixing and dispersing treatment over 30 minutes by employing mechanical type dispersion device having a circulation pass CLEARMIX manufactured by M Technique Co., Ltd., and dispersion composition containing emulsified particles (oil droplets) was prepared.

Solution of 13 parts by mass of potassium persulfate (KPS) dissolved in 260 parts by mass of ion exchanged water was added into the resulting dispersion composition, the temperature of the system was made 80° C. and polymerization reaction was conducted by heating and stirring over one hour. Thus Resin particles dispersion 1 for core was prepared. (Second Step Polymerization)

A solution of 12 parts by mass of potassium persulfate (KPS) dissolved in 240 parts by mass of ion exchanged water was added to the above described Resin particles dispersion for core, the temperature of the system was made 82° C. and then polymerizable monomer solution comprising 460 parts by mass of styrene, 173 parts by mass of n-butyl acrylate, and 10.5 parts of n-octyl mercaptane was dripped over 3 hours.

After completion of dripping, polymerization reaction was conducted by heating and stirring for 1 hour, and it was cooled down to 28° C. to obtain “Resin particles dispersion for core 1”. Herein, glass transition point of the resin particles for core was 33.1° C.

### (Preparation of Resin Particles Dispersions for Core 2, 5, 6, 8, 11, 13 and 14)

“Resin particles dispersions for core 2, 5, 6, 8, 11, 13 and 14” were prepared in the same procedure as Resin particles dispersion for core 1, except that the adding amounts of the monomers, potassium persulfate (KPS), n-octyl mercaptane (n-OM), and species and adding amount of wax were modified to as listed in Table 1.

### (Preparation of Resin Particles Dispersion for Core 3) (First Step Polymerization)

Into a reaction vessel equipped with a mechanical stirrer, a temperature sensor, a condenser, and a nitrogen gas directing tube, was loaded solution in which 1.3 parts by mass of sodium polyoxyethylene-2-dodecylether sulfate was dissolved in 1,300 parts by mass of ion exchanged water and heated to 80° C. Thereafter, added was polymerizable monomer solution in which 130 parts by mass of styrene, 47 parts by mass of n-butyl acrylate, 12 parts of methacrylic acid, 0.5 parts of n-octyl mercaptane, and 77.3 parts of HNP-019 were dissolved at 85° C. After that it was subjected to mixing and dispersing treatment over 30 minutes by employing mechanical type dispersion device having a circulation pass CLEARMLX manufactured by M Technique Co., Ltd., and dispersion composition containing emulsified particles (oil droplets) was prepared.

Solution of 7 parts by mass of potassium persulfate dissolved in 120 parts by mass of ion exchanged water was added into the resulting dispersion composition, the temperature of the system was made 80° C. and polymerization reaction was conducted by heating and stirring over one hour. Thus Resin particles dispersion for core was prepared. (Second Step Polymerization)

A solution of 11 parts by mass of potassium persulfate dissolved in 205 parts by mass of ion exchanged water was added to the above described Resin particles dispersion for core, the temperature of the system was made 82° C. and then polymerizable monomer solution comprising 406 parts by mass of styrene, 148 parts by mass of n-butyl acrylate, 38 parts by mass of methacrylic acid and 13.8 parts of n-octyl mercaptane was dripped over 3 hours.

After completion of dripping, polymerization reaction was conducted by heating and stirring for 1 hour, and it was cooled down to 28° C. to obtain “Resin particles dispersion 3 for core”.

### (Preparation of Resin Particles Dispersions for Core 4, 7, 9, 10, 12, 15, and 16)

“Resin particles dispersions for core 4, 7, 9, 10, 12, 15, and 16” were prepared in the same procedure as Resin particles dispersion for core 3, except that the adding amounts of the monomers, potassium persulfate (KPS), n-octyl mercaptane (n-OM), and species and adding amount of wax were modified to as listed in Table 1.

### (Preparation of Resin Particles Dispersion for Core 14)

“Resin particles dispersion for core 14” was prepared in the same procedure as Resin particles dispersion for core 1, except that the adding 101 parts by mass of “Electrol WEP-3” was modified to 90 parts by mass of “Elctrol WEP-5” and 11 parts by mass of “HNP-0190”.

Materials employed for preparation of resin particle dispersion for core were listed in Table 1.

TABLE 1

| No. of Resin | First Step Polymerization | | | | | | | Second Step Polymerization | | | | |
|---|---|---|---|---|---|---|---|---|---|---|---|---|
| particle | Monomer | | | | | Wax | | Monomer | | | | |
| dispersion | (parts by mass) | | | (parts by mass) | | (parts by mass) | | (parts by mass) | | | (parts by mass) | |
| for core | St | BA | MAA | KPS | n-OM | Name | Content | St | BA | MAA | KPS | n-OM |
| 1 | 255 | 114 | 21 | 13 | 10.5 | WEP-3 | 101.0 | 460 | 173 | 0 | 12 | 10.1 |
| 2 | 277 | 94 | 21 | 13 | 11.5 | WEP-3 | 101.0 | 494 | 139 | 0 | 12 | 10.2 |
| 3 | 130 | 47 | 12 | 7 | 0.5 | HNP-0190 | 77.3 | 406 | 148 | 38 | 11 | 13.8 |
| 4 | 130 | 47 | 12 | 7 | 0.5 | FNP-0090 | 77.3 | 406 | 148 | 38 | 11 | 13.8 |
| 5 | 318 | 51 | 21 | 14 | 11.0 | FNP-0090 | 101.0 | 563 | 70 | 0 | 15 | 10.1 |
| 6 | 255 | 114 | 21 | 13 | 10.5 | FT-100 | 101.0 | 460 | 173 | 0 | 13 | 10.1 |
| 7 | 133 | 48 | 9 | 7 | 0.5 | Hi-Mic-1090 | 77.0 | 416 | 149 | 27 | 11 | 13.7 |
| 8 | 286 | 84 | 21 | 14 | 11.0 | FNP-0085 | 101.0 | 510 | 123 | 0 | 12 | 10.3 |
| 9 | 255 | 114 | 21 | 13 | 10.5 | BE-205 | 101.0 | 460 | 173 | 0 | 12 | 10.1 |
| 10 | 272 | 98 | 21 | 13 | 10.6 | MDP7000 | 101.0 | 487 | 146 | 0 | 11 | 14.1 |
| 11 | 228 | 140 | 21 | 13 | 10.0 | FNP-0090 | 101.0 | 425 | 207 | 0 | 13 | 10.1 |
| 12 | 255 | 114 | 21 | 13 | 10.5 | FT-100 | 101.0 | 460 | 173 | 0 | 13 | 10.1 |
| 13 | 318 | 51 | 21 | 14 | 11.0 | Hi-Mic-1090 | 101.0 | 563 | 70 | 0 | 15 | 10.1 |
| 14 | 255 | 114 | 21 | 13 | 10.5 | WEP-5 | 90.0 | 460 | 173 | 0 | 13 | 10.1 |
| | | | | | | HNP-0190 | 11.0 | | | | | |
| 15 | 137 | 50 | 13 | 7 | 0.5 | HNP-0190 | 34.4 | 428 | 156 | 51 | 12 | 14.6 |
| 16 | 119 | 43 | 11 | 6 | 0.5 | HMP-0190 | 146.0 | 370 | 135 | 35 | 10 | 12.6 |

### (Preparation of Resin Particles Dispersion for Shell)

Into a reaction vessel equipped with a mechanical stirrer, a temperature sensor, a condenser, and a nitrogen gas directing tube, was loaded surfactant solution in which 1.5 parts by mass of sodium polyoxyethylene-2-dodecylether sulfate was dissolved in 3,000 parts by mass of ion exchanged water and heated to 80° C. while stirring at agitation speed of 230 rpm under nitrogen gas.

Into the surfactant solution, initiator solution in which 10 parts by mass of potassium persulfate (KPS) dissolved in 200 parts by mass of ion exchanged water was added and then polymerizable monomer solution comprising 520 parts by mass of styrene, 184 parts by mass of n-butyl acrylate, and 120 parts of methacrylic acid, and 22 parts of n-octyl mercaptan were dripped over 3 hours. After completion of dripping, polymerization reaction was conducted by heating and stirring for 1 hour at 80° C. to obtain “Resin particles dispersion for shell”. Herein, glass transition point of the resin particles for core was 51° C.

### <Preparation of Clear Toner 1>

### (Preparation of Core Particle 1)

Into a reaction vessel equipped with a mechanical stirrer, a temperature sensor, a condenser, and a nitrogen gas directing tube, 420 parts by mass of “Resin particle dispersion for core 1”, 1.5 parts by mass of sodium polyoxyethylene-2-dodecylether sulfate in terms of solids and 2,000 parts by mass of ion exchanged water. After adjusting the temperature inside of the reaction vessel at 25° C., 25% by mass of aqueous solution of sodium hydroxide was added to adjust pH of 10.

After that, an aqueous solution prepared by dissolving 70 parts by mass of magnesium chloride in 70 parts by mass of ion exchanged water was added spending 30 minutes at 30° C. while stirring. After standing for 3 minutes, the temperature was raised till particle diameter reached to 3 μm, and the growth of the above particles were continued while keeping the temperature and decreasing rotating speed.

In such the state, the diameter of the particles was measured by Multisizer 3, manufactured by Beckman Coulter Inc. When the diameter of the particles reached to 6.0 μm, rotating speed was increased and the growth of the particles was stopped by adding an aqueous solution prepared by dissolving 15 parts by mass of sodium chloride in 58 parts by mass of ion exchanged water to prepare “Core particle 1”.

(Preparation of Clear toner Mother Particle 1)

Into dispersion of Core particle 1, 30 parts by mass in terms of solids of “Resin particle dispersion for shell” was added for 25 minutes.

Small amount of resulting dispersion sample was treated via centrifuge separator. After confirming a supernatant being clear, rotation speed was increased and added was aqueous solution in which 60 parts by mass of sodium chloride was dissolved in 250 parts by mass of ion exchanged water to complete shelling process. Further, as a ripening process, the fusing was continued by heating and keeping at temperature by which circularity of the particles continuously increased, until the average circularity reached to 0.935 measured by PPIA-2100, manufactured by Sysmex Corp to form Clear toner Mother Particle. Then, the liquid temperature was cooled by 30° C. and the pH was adjusted to 2.0 by using hydrochloric acid, and stirring was stopped.

The solid ingredient of the above prepared Clear toner Mother Particle Dispersion was separated from the liquid ingredient by a basket type centrifuge separator Mark III 60×40, manufactured by Matsumoto Machine Mfg Co., Ltd., to prepare a wet cake of Clear toner Mother Particle. The wet cake was washed by ion-exchanged water of 45° C. by using the foregoing centrifuge separator until the electric conductivity of the filtrate became to 5 μS/cm, and then transferred to Flash Jet Dryer, manufactured by Seishin Enterprise Co., Ltd., and dried until the moisture content was reduced by 1.0% by mass to prepare “Clear toner Mother Particle 1”.(Addition of External Additives)

The following external additives were added to the above prepared “Clear toner Mother Particle 1” and treated by Henschel Mixer, manufactured by Mitsui Miike Mining Co., Ltd., to prepare “Clear toner 1”.

Hexamethylsilazane-treated Silica (Average primary particle diameter: 12 nm) 1.0 part by mass n-Octylsilane-treated titanium dioxide 0.3 parts by weight

The external additive treatment by Henschel mixer was carried out for 15 minutes at a circumference speed of the stirring wing of 35 m/sec and a treatment temperature of 35° C.

### <Preparation of Clear Toners 2, 5, 6, 10, 11, 13, and 14>

“Clear toners 2, 5, 6, 10, 11, 13, and 14” were prepared in the same manner as Clear toner 1 except for replacing “Resin particle dispersion for core 1” to “Resin particle dispersions for core 2, 5, 6, 10, 11, 13, and 14”.

### <Preparation of Clear Toner 3>

Into a reaction vessel equipped with a mechanical stirrer, a temperature sensor, a condenser, and a nitrogen gas directing tube, 450 parts by mass of “Resin particle dispersion for core 3”, 1.5 parts by mass of sodium polyoxyethylene-2-dodecylether sulfate in terms of solids and 2,000 parts by mass of ion exchanged water. After adjusting the temperature inside of the reaction vessel at 25° C., 25% by mass of aqueous solution of sodium hydroxide was added to adjust pH of 10.

After that, an aqueous solution prepared by dissolving 70 parts by mass of magnesium chloride in 70 parts by mass of ion exchanged water was added spending 30 minutes while stirring. After standing for 3 minutes, the temperature was raised till particle diameter reached to 3 μm, and the growth of the above particles were continued while keeping the temperature and decreasing rotating speed.

In such the state, the diameter of the particles was measured by Multisizer 3, manufactured by Beckman Coulter Inc. When the diameter of the particles reached to 6.0 μm, rotating speed was increased and the growth of the particles was stopped by adding an aqueous solution prepared by dissolving 73 parts by mass of sodium chloride in 300 parts by mass of ion exchanged water.

Further, the fusing was continued by heating and keeping at temperature by which circularity of the particles continuously increased, until the average circularity reached to 0.935 measured by PPIA-2100 to form Clear toner Mother Particle. After that, the liquid temperature was cooled by 30° C. and the pH was adjusted to 2.0 by using hydrochloric acid, and then stirring was stopped.

The solid ingredient of the above prepared Clear toner Mother Particle Dispersion was separated from the liquid ingredient by a basket type centrifuge separator Mark III 60×40, manufactured by Matsumoto Machine Mfg Co., Ltd., to prepare a wet cake of Clear toner Mother Particle. The wet cake was washed by ion exchanged water of 45° C. by using the foregoing centrifuge separator until the electric conductivity of the filtrate became to 5 μS/cm, and then transferred to Flash Jet Dryer, manufactured by Seishin Enterprise Co., Ltd., and dried until the moisture content was reduced by 1.0% by mass to prepare “Clear toner Mother Particle 3”. (Addition of External Additives)

“Clear toner 3” was prepared by adding the same external additives as “Clear toner 1” to 100 parts by mass of the above prepared “Clear toner Mother Particle 3”.

### <Preparation of Clear Toners 4, 7, 8, 9, 12, 15, and 16>

“Clear toners 4, 7, 8, 9, 12, 15, and 16” were prepared in the same manner as Clear toner 3 except for replacing “Resin particle dispersion for core 3” to “Resin particle dispersions for core 4, 7, 8, 9, 12, 15, and 16”.

In Table 2, listed were the addition amounts of dispersions and waxes employed in the preparation of “Clear toners 1 to 16”, glass transition points (Tg) of resins, crystallization temperatures (Tc) of waxes and values of (Tc−Tg).

TABLE 2

| | Composition | | Content of Wax | Physical property | | |
|---|---|---|---|---|---|---|
| | No. of Resin | No. of Resin | in Resin particle | | Crystallization | |
| No. of | particle | particle | dispersion | Glass transition | temperature | |
| Clear | dispersion | dispersion | for Core | point of Resin | of Wax | (Tc − Tg) |
| toner | for Core | for Shell | (% by mass) | (Tg) (° C.) | (Tc) (° C.) | (° C.) |
| 1 | 1 | 1 | 9.0 | 33.1 | 63.5 | 30.4 |
| 2 | 2 | 1 | 9.0 | 39.0 | 63.5 | 24.5 |
| 3 | 3 | — | 9.0 | 48.0 | 81.5 | 33.5 |
| 4 | 4 | — | 9.0 | 48.0 | 85.5 | 37.5 |
| 5 | 5 | 1 | 9.0 | 68.0 | 85.5 | 17.5 |
| 6 | 6 | 1 | 9.0 | 33.0 | 94.4 | 61.4 |
| 7 | 7 | — | 9.0 | 45.0 | 75.0 | 30.0 |
| 8 | 8 | — | 9.0 | 50.0 | 66.1 | 16.1 |
| 9 | 9 | — | 9.0 | 33.0 | 57.0 | 24.0 |
| 10 | 10 | 1 | 9.0 | 43.0 | 110.0 | 67.0 |
| 11 | 11 | 1 | 9.0 | 28.0 | 85.5 | 57.5 |
| 12 | 12 | — | 9.0 | 73.0 | 94.4 | 21.4 |
| 13 | 13 | 1 | 9.0 | 68.0 | 75.0 | 7.0 |
| 14 | 14 | 1 | 9.0 | 33.0 | 68.0 | 35.0 |
| 15 | 15 | — | 4.0 | 48.0 | 81.5 | 33.5 |
| 16 | 16 | — | 17.0 | 48.0 | 81.5 | 33.5 |

Herein, glass transition point of resin and crystallization temperature of wax were determined in the same manner as described before.

### <<Evaluation>>

### (Preparation of Glossy Printed Matter)

For preparation of glossy printed matter, used was Electrophotographic image forming apparatus “bizhub C353” (manufactured by Konica Minolta Business Technologies Inc.) in which “Clear toner particle layer forming unit 20S” shown in FIG. 2 was additionally installed. Each clear toner prepared above was charged in turn into the evaluation apparatus, formed the clear toner layer on the whole surface of the image support materials in an amount of 4 g/m² and heating/pressuring to prepare the glossy printed matter.

“OK Top Coat Paper” (weight: 157 g/m², thickness: 131 μm) manufactured by Oji Paper Co., Ltd. was used as the image support material. Ambient condition for evaluation was set at normal temperature and humidity (20° C., 50% R.H.).

### <Evaluation of High Glossy Printed Matter>

Glossy printed matter prepared above was passed through the high glossiness providing apparatus shown in FIG. 8 to form High glossy printed matter. Resulting high glossy printed matter was evaluated in terms of glossiness and releasing performance of the image support material from the belt of high glossiness providing apparatus.

The conditions of high glossiness providing apparatus were as follows:
(a) Material of the belt: Polyimide film (thickness: 50 μm) with PFA layer (thickness: 10 μm)
(b) Roughness of belt surface (initial surface roughness): Ra 0.4 μm
(c) Specification of heating and pressuring roller

Heating roller: Aluminum substrate having an outer diameter of 100 mm and a thickness of 10 mm covered with a silicone rubber layer of 3 mm. A halogen lump was provided inside of the heating roller.

Pressuring roller: Aluminum substrate having an outer diameter of 80 mm and a thickness of 10 mm covered with a silicone rubber layer of 3 mm

Nipping width between the heating roller and the pressuring roller: 9 mm

Nipping pressure between the heating roller and the pressuring roller: 600 kPa
(d) Distance from the nipping portion between the heating roller and the pressuring roller to the position of releasing roller: 620 mm
(e) Transferring rate of the image support material: 110 mm/second
(f) Heating condition: Surface temperature of the belt at just before nipping portion between the heating roller and the pressuring roller was determined via contact type thermometer and set to be T1 by controlling conditions for the halogen lump provided inside of the heating roller.
(g) Cooling conditions: Surface temperature of the high glossy clear toner layer at releasing portion of the image support material from cooling and releasing belt was determined via noncontact type thermometer and set to be T2 by controlling conditions for cooling.
(h) Transferring direction of the image support material: A4 size of image support material was transferred in the length direction.
(i) Evaluation environment: Ordinary temperature and humidity (20° C., 50% R.H.)

### (Evaluation of Glossiness)

Glossiness was measured and evaluated by employing a glossimeter described above, wherein measurement angle was set as 20° and averaged of 10 random measured values. The samples having glossiness of 80 or more at measurement angle as 20° were classified as acceptable.

(Evaluation of Releasing Performance from Belt)

High glossiness treatment was conducted on 100 glossy printed matters via the high glossiness providing apparatus described above. Releasing performance from belt was evaluated by state of wrapping of the image support material to the cooling/releasing member via visual inspection. Rank A and B were classified as acceptable.

Rank for Evaluation

A: No wrapping was observed in all of 100 printed matters.

B: No wrapping was observed in all of 100 printed matters, but 1-3 printed matters adhered and were lifted onto the cooling/releasing member of the high glossiness providing apparatus.

C: Wrapping was observed around the cooling/releasing member of the high glossiness providing apparatus.

The result is summarized in Table 3.

TABLE 3

| No. of | | | High | | | | High | | | | | |
|---|---|---|---|---|---|---|---|---|---|---|---|---|
| High | | Wax | glossiness | | | | glossiness | | | | | |
| glossy | No. of | content in | providing | Wax | | | providing | | | Evaluation | | |
| printed | Clear | toner (% | apparatus | Tc | T1 − Tc | Resin Tg | apparatus | Tg − T2 | Tc − Tg | Glossiness | Releasing | Remarks |
| matter | toner | by mass) | T1 (° C.) | (° C.) | (° C.) | (° C.) | T2 (° C.) | (° C.) | (° C.) | (20°) | performance | *1 |
| 1 | 1 | 8.4 | 180.0 | 63.5 | 116.5 | 33.1 | 50.0 | −16.9 | 30.4 | 90 | A | Inv. 1 |
| 2 | 2 | 8.4 | 180.0 | 63.5 | 116.5 | 39.0 | 55.0 | −16.0 | 24.5 | 90 | A | Inv. 2 |
| 3 | 3 | 9.0 | 180.0 | 81.5 | 98.5 | 48.0 | 60.0 | −12.0 | 33.5 | 90 | A | Inv. 3 |
| 4 | 4 | 9.0 | 180.0 | 85.5 | 94.5 | 48.0 | 70.0 | −22.0 | 37.5 | 91 | A | Inv. 4 |
| 5 | 5 | 8.4 | 180.0 | 85.5 | 94.5 | 68.0 | 50.0 | 18.0 | 17.5 | 91 | A | Inv. 5 |
| 6 | 6 | 8.4 | 180.0 | 94.4 | 85.6 | 33.0 | 55.0 | −22.0 | 61.4 | 95 | A | Inv. 6 |
| 7 | 7 | 9.0 | 180.0 | 75.0 | 105.0 | 45.0 | 65.0 | −20.0 | 30.0 | 88 | A | Inv. 7 |
| 8 | 8 | 9.0 | 180.0 | 66.1 | 113.9 | 50.0 | 55.0 | −5.0 | 16.1 | 87 | A | Inv. 8 |
| 9 | 9 | 9.0 | 180.0 | 57.0 | 123.0 | 33.0 | 57.0 | −24.0 | 24.0 | 65 | B | Comp. 1 |
| 10 | 10 | 8.4 | 180.0 | 110.0 | 70.0 | 43.0 | 50.0 | −7.0 | 67.0 | 71 | A | Comp. 2 |
| 11 | 11 | 8.4 | 180.0 | 85.5 | 94.5 | 28.0 | 50.0 | −22.0 | 57.5 | *2 | C | Comp. 3 |
| 12 | 12 | 9.0 | 180.0 | 94.4 | 85.6 | 73.0 | 55.0 | 18.0 | 21.4 | 70 | A | Comp. 4 |
| 13 | 13 | 8.4 | 180.0 | 75.0 | 105.0 | 68.0 | 50.0 | 18.0 | 7.0 | 80 | A | Inv. 9 |
| 14 | 14 | 8.4 | 180.0 | 68.0 | 112.0 | 33.0 | 50.0 | −17.0 | 37.1 | 93 | A | Inv. 10 |
| 15 | 15 | 4.0 | 180.0 | 81.5 | 98.5 | 48.0 | 70.0 | −22.0 | 33.5 | 92 | A | Inv. 11 |
| 16 | 16 | 17.0 | 180.0 | 81.5 | 98.5 | 48.0 | 70.0 | −22.0 | 33.5 | 87 | A | Inv. 12 |
| 17 | 4 | 9.0 | 150.0 | 85.5 | 64.5 | 48.0 | 50.0 | −2.0 | 37.5 | 81 | A | Inv. 13 |
| 18 | 4 | 9.0 | 180.0 | 85.5 | 94.5 | 48.0 | 75.0 | −27.0 | 37.5 | 83 | B | Inv. 14 |

*1: Inv.: Inventive example, Comp.; Comparative example
*2: Unmeasurable

As is apparent from Table 3, “High glossy printed matters 1 to 8 and 13 to 18” employing “Clear toners 1 to 8 and 13 to 16” of the present invention were confirmed to satisfy all the evaluation items. On the contrary, “High glossy printed matters 9 to 12” employing “Clear toners 9 to 12” were confirmed to exhibit problems in either evaluation items. Herein, “Clear toner 11” caused the wrapping and was unable to prepare a print for glossiness evaluation.

What is claimed is:

1. A method for forming a high glossy printed matter comprising at least steps of:
(a) heating and melting a clear toner supplied on an image support material,
(b) bringing the image support material at a side in which the a clear toner is supplied into contact with a belt, and cooling the transparent toner while contacting with the belt, and
(c) releasing the image support material from the belt,
wherein the clear toner comprises at least a resin and a wax,
a glass transition point (Tg) of the resin is not less than 30° C. and not more than 70° C., and
a crystallization temperature (Tc) of the wax is not less than 60° C. and not more than 99° C.

2. The method for forming the high glossy printed matter of claim 1,
wherein Tg and Tc satisfies the following relation:
(Tc−Tg)≧15° C.,
wherein Tg represents a glass transition point (Tg) of the resin and Tc represents a crystallization temperature (Tc) of the wax.

3. The method for forming the high glossy printed matter of claim 1,
wherein the resin is obtained by polymerizing at least styrene monomer, butyl acrylate monomer and methyl methacrylate monomer, and
a content of the wax is not less than 4% by mass and not more than 17% by mass based on a total clear toner.

4. The method for forming the high glossy printed matter of claim 1,
wherein Tg, Tc, T1 and T2 satisfies the following relation:
(T1−Tc)≧70° C., and
(Tg−T2)≧−25° C.,
wherein Tg represents a glass transition point (Tg) of the resin, Tc represents a crystallization temperature (Tc) of the wax, T1 represents a surface temperature of a cooling and releasing belt just before the image support material being nipped with the heating and pressuring member, and T2 represents a surface temperature of the high glossy clear toner layer just after the image support material being released from the cooling and releasing belt of the cooling and releasing member.

5. The method for forming the high glossy printed matter of claim 1 comprising further step of: heating and pressuring a clear toner particle layer before the step of (a).
